(19) United States
(12) Patent Application Publication
(10) Pub. No.: US 2018/0075550 A1
(43) Pub. Date: Mar. 15, 2018

(54) SYSTEMS AND METHODS FOR REMOTE ESTIMATION OF EXTERIOR BUILDING FEATURES

(71) Applicant: Remote Sales Force, LLC, Carmel, IN (US)

(72) Inventors: Christopher T. Thornberry, Indianapolis, IN (US); Mark F. Garringer, Eaton, IN (US); Dale R. Thornberry, Noblesville, IN (US); Michael J. Damora, Stanhope, NJ (US)

(73) Assignee: Remote Sales Force, LLC, Carmel, IN (US)

(21) Appl. No.: 15/700,906

(22) Filed: Sep. 11, 2017

Related U.S. Application Data
(60) Provisional application No. 62/385,973, filed on Sep. 10, 2016.

(51) Int. Cl. G06Q 50/08; G06Q 10/08; G06Q 30/06

(52) U.S. Cl. CPC G06Q 50/08; H04L 67/42; G06Q 30/0611; G06Q 10/0875

(57) ABSTRACT

One form of the present application is directed to a terminal in communication with at least one server via an Internet based communication network, wherein the terminal is associated with a user, and wherein the terminal is structured to execute an estimation and visualization application which, when executed: receives client contact information and a work description, receives a set of measurements for the work to be performed, retrieves at least one photograph depicting a portion of the structure on which exterior work is to be performed, generates a visualization depicting the structure as it will appear after the work is performed thereon, and generates a cost estimate of work to be performed, based at least in part on the work description and the measurements.

### RELATED APPLICATION DATA

This application claims priority to U.S. Provisional Application No. 62/385,973 filed Sep. 10, 2016, the entire contents of which are incorporated herein by reference.

### BACKGROUND

The current process for purchasing exterior building products is often time consuming and frustrating. This process typically involves appointments with sales representatives, having those representatives at your home to take measurements, in-home sales meetings to discuss the scope of work to be performed, and enduring lengthy product presentations. Homeowners are often subject to high pressure sales pitches. A savvy consumer will typically want estimates from multiple companies, which will require the homeowner to be subject to this process several times over. Accordingly, there remains a need for further contributions in this area of technology.

### SUMMARY

One form of the present application includes a system for the off-site estimation of exterior building features. Other forms include unique remote exterior construction estimation apparatuses, systems, and methods. Further embodiments, inventions, forms, objects, features, advantages, aspects, and benefits of the present application are otherwise set forth or become apparent from the description and drawings included herein.

### BRIEF DESCRIPTION OF THE DRAWINGS

The description herein makes reference to the accompanying drawings wherein like reference numerals refer to like parts throughout the several views, and wherein:

FIG. 1 is a schematic illustration of one form of a remote exterior construction estimation system;

FIG. 2 depicts one form of a user interface of the remote exterior construction estimation system of FIG. 1;

FIG. 3 depicts a flow diagram of a process for the off-site estimation of exterior building features; and

FIG. 4 is a schematic representation of remote sales system for exterior building features.

### DETAILED DESCRIPTION

For purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated device, and any further applications of the principles of the invention as illustrated therein being contemplated as would normally occur to one skilled in the art to which the invention relates.

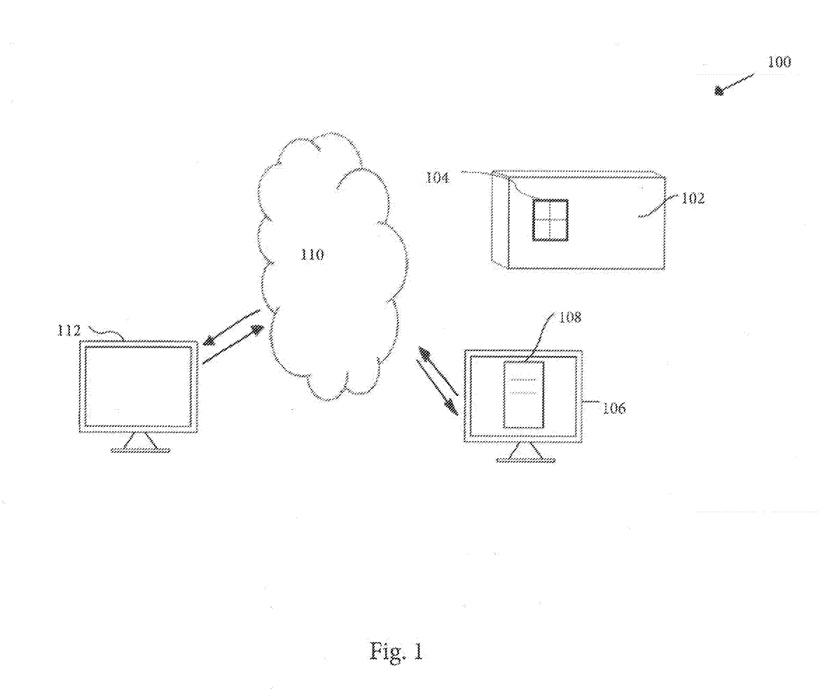

FIG. 1 depicts one form of a remote exterior construction estimation system 100. A client terminal 106 communicates with the Internet 110, and can communicate with a vendor terminal 112 via the Internet 110. The client terminal 106 includes memory, processing, display, and communication hardware and can generate at least one web based browser, such as Internet Explorer®, Mozilla Firefox, Google Chrome, and so forth. It is envisioned that the client terminal 106 can be a desktop computer, laptop computer, smartphone, tablet, or any other type of computing device capable of generating and displaying a web browser.

The client terminal 106 is configured to generate and display a remote estimation application 108. The remote estimation application 108 facilitates the communication of information between the client terminal 106 and the vendor terminal 112 such that an estimate for exterior building features can be received by the user of the client terminal 106 without the need for a vendor to be physically present at the location of the structure. As will be discussed hereinafter, the remote estimation application 108 can permit a user to render, visualize, and price actual budding products on their home, as well as scheduling and attending sales appointments via webinar, from the comfort of their home in real-time.

Although the remote estimation application 108 can take various forms, the remote estimation application 108 is depicted as a web based remote estimation tool 108, able to send and retrieve data via the Internet 110. When it is desired for a building structure 102 to have one or more exterior improvements made thereto, such as the installation of a new window 104, a user is able to submit a request for an estimate and receive such estimate via the estimation application 108.

It is envisioned that the user of the client terminal 106 is the owner of the property 102—as would likely be the case with a home, a property manager or other person with control over the appearance and/or upkeep of the building 102—as can be the case with a hotel building, or can be any other user who desires a remote estimate for a structure 102. Moreover, it is contemplated that building structure 102 can be any type of structure, including, but not limited to single-family houses, residential apartment buildings, commercial buildings, or any other type of structure where one or more exterior building features can be incorporated therein or added thereto.

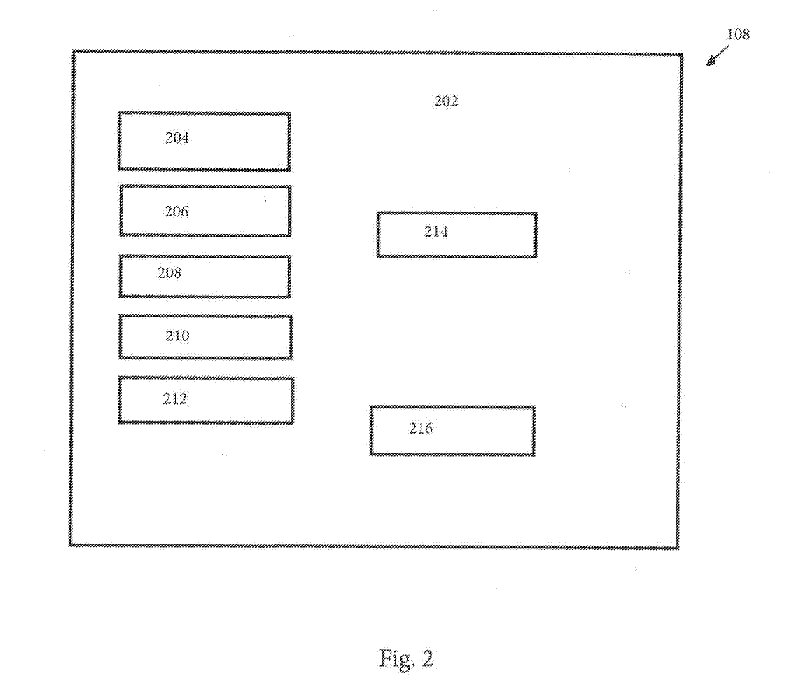

FIG. 2 depicts one form of a user interface 202 of the estimation application 108. This user interface 202 receives various inputs from the user via the client terminal 106 and can generate and/or display various outputs to the user via the client terminal 106. This user interface 202 includes a customer contact input field 204, a work description input field 206, a manual/automatic photograph input field 208, a manual/automatic measurements input field 210, and a submit field 212. The user interface 202 also includes a display visualization output field 216 and a display estimate output field 216. In various forms, these input fields can include manual data entry fields configured to receive text or photographs, can include drop down menus with various data from which a user may select, various check boxes, or the like.

Although specific input and output fields will be described herein, it is contemplated that the user interface 202 can take a variety of forms such that information to process an estimate for exterior building construction can be received from a user and a visualization and estimate can be displayed to the user. Moreover, in various forms fields may be combined (e.g. the display visualization field 214 may also include the estimate rendering the display estimate field 216 redundant), additional fields may be present (e.g. a contact vendor field may be present which will activate a webinar between the client terminal 106 and the vendor terminal 112 and a help field may be present), or one or more fields may not be physically present (e.g. rather than a display estimate field 216 and a display visualization field 214, the estimate and the visualization may simply be displayed to the user). In further forms, a vendor can input data into one or more input fields of the estimation application 108 via the vendor terminal 112.

The remote estimation application 108 receives and processes customer contact information received from the customer contact input field 204. The customer contact information can be used to reference the customer or project. Exemplary customer contact information includes, but is not limited to, name (first, middle, and/or last), phone number(s), email address, physical address, and mailing address.

The work description input field 206 receives input from the user regarding the type of work the user desires to have performed on the structure 102. In one form, a user can select the type of project, such as from a drop down menu. These project types can include, but are not limited to: roofing, siding, windows, doors, garage doors, brick/masonry, or the like. In other forms, a user can enter specific building products of interest. The user can choose among a variety of criteria, such as they are interested, in product type, color, texture, manufacturer, model or sku number, product name or the like.

The manual/automatic photograph input field 208 receives or generates a photograph of the structure 102 on which the exterior work is to be performed. In one form, the input field 208 permits a user to manually upload a photograph (e.g. a smartphone-based image may be uploaded by the customer). In a further form, the application automatically retrieves the photograph from an Internet 110 based mapping service, which include, but are not limited to: Google Street View, images from county databases, and aerial and satellite imagery services.

The manual/automatic measurement input field 210 receives or generates the measurements to determine the materials required for a specific project. These measurements can be manually retrieved and entered by the user in the client terminal 106, can be manually entered into the application 108 by a vendor through the vendor terminal 112, or can be automatically retrieved and exported from various measurement acquisition software. For example, measurements can be retrieved from an aerial/satellite roof measurement report from a managed service such as: Eagleview Technologies, AerialReports.com, CoreLogic SkyMeasure, Aerial Estimation, Skytek Imaging, RoofScope.com.

Additionally, measurements can be retrieved from an aerial/satellite wall measurement report service such as: Eagleview Technologies and SidingScope.com. Measurements can also be retrieved from a smartphone-based image capture and 2 dimensional report or 3 dimensional model, such as HOVER (http://hover.to), Spike by IkeGPS, GoFigure, and Stanley SmartMeasure Pro.

The measurements can be retrieved from remote sensed measurements using a do-it-yourself type tool, such as Pictometry Online, Pictometry ConnectExplorer, and Google Maps. In some forms, the measurements can be exported in a computer-readable format (such as flat file text, xml, json, or various other proprietary formats).

As will be understood by one of ordinary skill in the art, the measurements to be entered or retrieved are dependent upon the type of work to be performed on the structure 102. For example, exemplary roofing measurements can include: total area, area broken down by area per pitch value, lineal feet of ridge, lineal feet of valley, lineal feet of eave, lineal feet of rake, and lineal feet of step and head flashing.

Exemplary siding/masonry measurements can include: total area, area broken down by surface type, area of openings, inside quantity of corners, inside length of corners, outside quantity of corners, outside length of corners, trim level starter, trim head flashing, trim sloped, vertical trim, roofline eaves fascia, roofline level frieze board (length, average depth, soffit area), roofline rakes fascia length, roofline sloped frieze board length and soffit area, quantity of openings, opening tops length, opening sills length, opening sides length, and the quantity, length, and area of any accessories such as shutters or vents. Additionally and/or alternatively these measurements can be broken down by surface type.

The measurements can also include more detailed data available on an individual facade basis. This detailed measurement data can include individual window measurements, such as an opening Identifier (corresponds to 2D/3D representations of the property), width, height, United Inches, and area, as well as individual door measurements, such as an opening identifier (corresponds to 2D/3D representation of the property), width, height, and area.

Upon entry of the desired input data, a user may activate the submit field 212. This submit field 212 can trigger the transference of the data input by the user between the client terminal 106 and the vendor terminal 112.

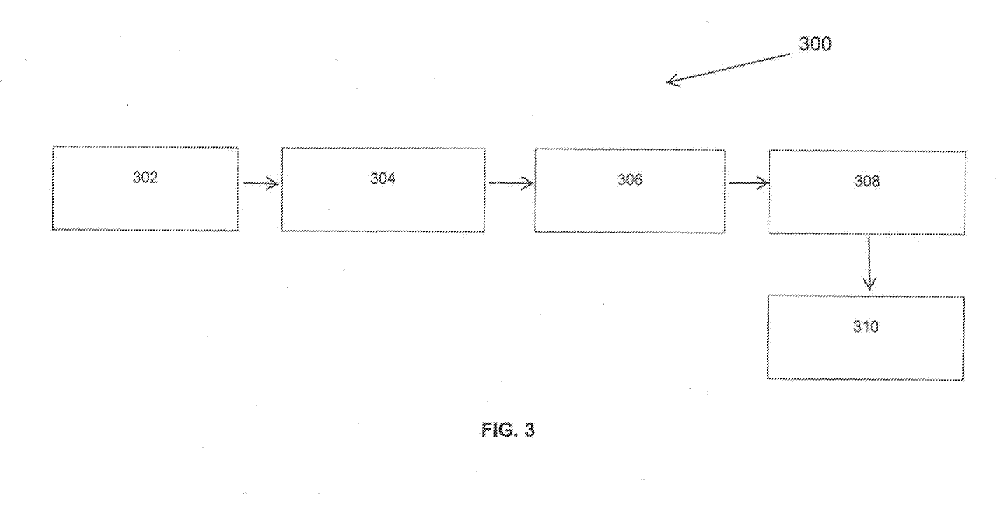

FIG. 3, depicts a flow diagram of a process 300 for the off-site estimation of exterior building features. 302 depicts the gathering of customer contact information and 304 depicts the gathering of photographs and measurements, as have previously been discussed herein. 306 depicts determining the quantities of materials for the work on the structure 102 and generating a visualization of the structure 102 as it would appear after the construction has been performed. 308 depicts closing the deal remotely and 310 depicts the final agreement between the vendor and the client being approved.

The quantities of materials are determined based upon the type of work to be performed on the structure and the measurements received. In one form, the remote estimation application 108 can automatically calculate material quantities. In a further form, the vendor can input the quantities of materials into the remote estimation application 108 via the vendor terminal 112.

A visualization of the structure 102 as it will appear after the desired work has been performed can be generated from the photograph, measurements, and other inputs as were previously described. A remote sales representative of the vendor can utilize a visualization tool on the vendor terminal 112 to generate such visualization. Although the use of various rendering/visualization tools are contemplated, one such visualization tool is Renoworks Pro. The sales representative will then load the visualization into the remote estimation application 108.

A cost estimate including the protected cost of the project is determined based upon the material quantity and type of materials selected. Although it is contemplated that the remote estimation application 108 can automatically generate a complete estimate, in other forms the estimate is at least in part input into the remote estimation application via the vendor terminal 112.

The estimate and visualization can be viewed by the user on the client terminal 106 in the display visualization output field 216 and a display estimate output field 216. The remote estimation application 108 permits the user to vary and substitute various features within the visualization to better determine which changes/types of changes they want to be incorporated into the structure 102. As changes are made to the materials, scope of work, etc. the cost estimate is additionally updated to reflect the cost of such variations and substitutions to the user.

The remote estimation application 108 can further facilitate webinar communication between a user via the client terminal 106 and the vendor terminal 112. Webinar communication can be facilitated through a variety of services which include, but are not limited to, GotoMeeting, RingCentral Meetings, Glance, and Cisco WebEx.

Once the final quantities have been verified and the homeowner and sales representative have come to an agreement on the appropriate products, colors, quantities, charges, and the like a final agreement is executed. The final agreement may be executed in one of the following ways: paper signature in person, paper signature via electronic communication (fax, email, etc.), paper signature via some type of courier service (including but not limited United States Postal Service, FedEx, UPS, DHL, etc.), electronic signature in person, electronic signature remotely using some type of electronic signature service or product (including but not limited to esign, docusign, etc.).

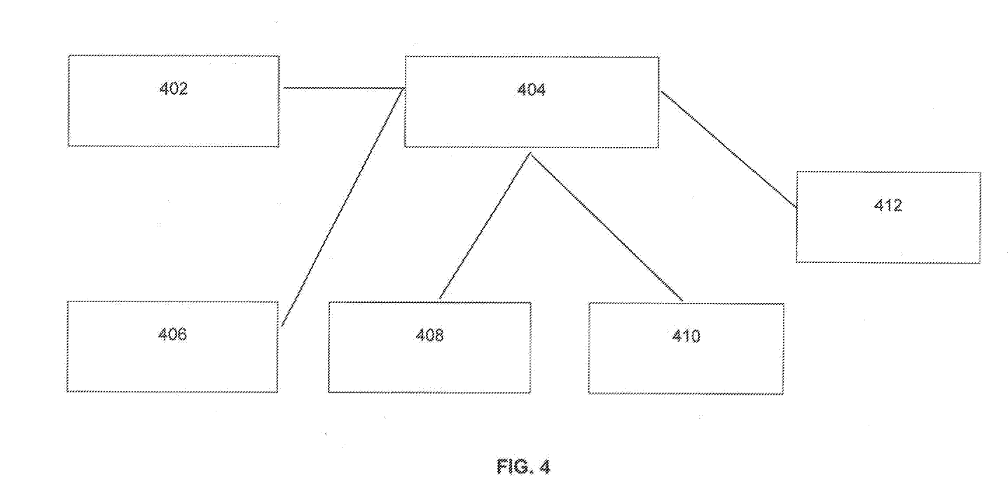

FIG. 4 depicts a remote sales system for exterior building features.

### Estimate/Proposal 404

The estimate/proposal 404 uses the other items in the system to deliver a summary to the customer(s) (including but not limited to homeowner, property manager, building owner, etc.) the information needed in order to complete the transaction.

### Webinar 402

The Webinar 402 allows the customer(s) to be in a variety of physical locations. The only requirement is the ability to have access to a device with the ability to connect to a communication network (including but not limited to phone, internet, etc.). It should also be noted that in the case of multiple customers involved they would not have to be located in the same physical location. The base requirement of a device that allows them to connect to a communication network.

### Measurement 408

Measurements can be acquired through automated methods of measurement acquisition, manual remote measurement acquisition, and/or manual on-site measurement acquisition.

These measurements will be inputted into the remote selling system. The system may take the input of those measurement either manually imported or some type of computer-readable format.

### Product Pricing and Information 406

This component 406 would store (potentially per company) a list of product(s) and options available along with their associated prices, specifications (including marketing collateral, engineering documents, product installation videos or resources, product swatches, color details, etc.), stored in the system.

The sales representative/user would have access to product collateral to use during the sales process to help educate the customer on the strengths and weaknesses of different products.

As the representative makes selections including but not limited to product, product options, sizes, discounts, etc. the system will continually take the pricing, quantity, and pricing calculation information/formulas and develop a price for the customer.

### Rendering/Visualization Tools 410

This provides the ability for us to be able to provide rendering and/or visualization services to the customer. This allows a sales representative to become more of a design consultant than a salesperson in the exchange. This can create a more comfortable experience for the customer.

This portion of the process would allow the user of the system to be able to show the customer what a building material(s) would look like on their specific home. This rendering could be provided in a variety of different formats. It could be a 2D representation of the home or some sort of 3D rendering/representation of the building products on their home.

### Documents 412

Once the customer and salesperson have agreed upon the specific product(s), the price, timing, and other financial/legal details on their project they would then create a formal proposal for acceptance by the customer.

Various documents can be made available to the customer, such as an electronic copy of the proposal with functionality to allow them to digitally sign the document remotely and execute the agreement.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A system, comprising:
a terminal in communication with at least one server via an Internet based communication network, wherein the terminal is associated with a user, and wherein the terminal is structured to execute an estimation and visualization application configured, when executed, to:
receive client contact information and a work description, wherein the client contact information and the work description are structured to be input into the estimation application by the user;
receive a set of measurements for the work to be performed;
retrieve at least one photograph depicting a portion of the structure on which exterior work is to be performed;
generate a visualization depicting the structure as it will appear after the work is performed thereon, wherein the visualization is based at least in part on the work description and the photograph;
generate a materials list, wherein the materials list is based at least in part on the measurements and the work description; and
generate a cost estimate of work to be performed, based at least in part on the work description and the materials list.

2. The system of claim 1, wherein the application structured to permit property owner to upload the photograph.

3. The system of claim 1, wherein the client contact information includes at least a property address, and wherein the photograph is retrieved from an Internet based mapping service.

4. The system of claim 1, wherein the application is structured to permit the property owner to input the measurements which the property owner has manually taken.

5. The system of claim 1, wherein the application is structured to receive the measurements from at least one of an aerial measurement report, a satellite measurement report, a remote sensed measurement calculation application, and a photograph-to-measurement calculation application.

6. The system of claim 1, wherein the application is further structured to display the visualization thereon, and wherein the application permits the user to alter at least one parameter of the visualization thereby enabling the user to view various changes to the structure as they would appear incorporated into the structure.

7. The system of claim 6, wherein the application is further structured to facilitate webinar based communication.

8. A computer-implemented method for remote estimation of exterior building products, comprising:
generating an application on a computer terminal in communication with at least one server via an Internet based communication network, wherein the application is structured to receive client contact information, a photograph of a structure on which work is to be performed, and a work description;
receiving the client contact information input by a property owner, wherein the client contact information is input by the property owner via the application and includes at least the address of the structure;
receiving the photograph depicting at least a portion of the structure;
receiving the work description input by the property owner via the application;
receiving a set of measurements for the work to be performed;
generating a visualization depicting the structure as it would appear after the work has been performed thereon, wherein the visualization is based at least in part on the photograph and the work description, wherein the visualization is displayed to the property owner via the application;
generating a materials list, wherein the materials list is based at least in part on the work description and the measurements; and
generating a cost estimate of work to be performed, based at least in part on the materials list, wherein the cost estimate is displayed to the property owner via the application.

9. The method of claim 8, wherein receiving the photograph further comprises retrieving the photograph from an Internet based mapping service.

10. The method of claim 8, wherein the application is structured to permit the property owner to upload the photograph.

11. The method of claim 8, wherein the application is structured to receive the measurements from at least one of manually input measurements from the property owner, an aerial measurement report, a satellite measurement report, a remote sensed measurement calculation application, and a photograph-to-measurement calculation application.

12. The method of claim 11, wherein generating a visualization further comprises altering one or more parameters of the visualization thereby enabling the property owner to view various changes to the structure as they would appear incorporated into the structure.

13. The method of claim 12, wherein altering one or more parameters of the visualization comprises altering at least one of a construction material type and a construction material color.

14. The method of claim 13, further comprising facilitating webinar based communication between the property owner and at least one vendor.

15. The method of claim 14, further comprising finalizing a scope of work agreement between the property owner and the vendor.

16. The method of claim 15, further comprising signing, in a remote electronic manner, the scope of work agreement.
